(19) United States
(12) Patent Application Publication
(10) Pub. No.: US 2018/0220798 A1
(43) Pub. Date: Aug. 9, 2018

(54) SYSTEM OF TOOL-LESS ATTACHMENT OF DRAWER SLIDES AND METHOD THEREOF

(71) Applicant: Lockdowel, Inc., Fremont, CA (US)

(72) Inventors: Bryan Koelling, Carmel Valley, CA (US); Daniel Savage, San Mateo, CA (US); Hoang Dang, San Jose, CA (US)

(21) Appl. No.: 15/942,378

(22) Filed: Mar. 30, 2018

Related U.S. Application Data
(63) Continuation-in-part of application No. 15/729,664, filed on Oct. 10, 2017.
Application No. 15/729,664 is a continuation-in-part of application No. 15/215,506, filed on Jul. 20, 2016.
(60) Provisional application No. 62/405,809, filed on Oct. 7, 2016.
(60) Provisional application No. 62/194,800, filed on Jul. 20, 2015.
(60) Provisional application No. 62/245,211, filed on Oct. 22, 2015.

(51) Int. Cl. A47B 88/427; A47B 88/43; F16B 12/10

(52) U.S. Cl. CPC A47B 88/427; F16B 13/14; F16B 12/10; A47B 88/43

(57) ABSTRACT

A system of tool-less attachment of drawer slides/mounts comprising pre-attached/pre-installed fasteners on a substrate that lock with corresponding pre-machined receiving openings. There is a method of installation of drawer slides to a cabinet system wherein the pre-attached/pre-installed insertion component is press-fit into a pre-machined receiving point located on a panel of a drawer box and the pre-attached/pre-installed fastening component is locked with a pre-machined mating point on the cabinet framework.

### CROSS-REFERENCE TO RELATED APPLICATION

This application is a continuation-in-part of co-pending U.S. application Ser. No. 15/729,664, filed on Oct. 10, 2017 which claims the benefit of U.S. Provisional Application No. 62/405,809, filed Oct. 7, 2016; and is a continuation-in-part of co-pending U.S. application Ser. No. 15/215,506, filed Jul. 20, 2016 which claims the benefit of U.S. Provisional Application No. 62/194,800, filed Jul. 20, 2015 and U.S. Provisional Application No. 62/245,211, filed Oct. 22, 2015; each of which is hereby incorporated by reference in its entirety.

### BACKGROUND OF THE INVENTION

### 1. Field of the Invention

This invention relates to tool-less attachment of drawer slides; more particularly pre-installed/pre-attached fasteners used for attaching drawer slides to drawer boxes, panels of cabinet framework, and other furniture having pre-machined receiving openings without the use of tools.

### 2. Background

The process of mounting drawer slides to cabinetry and furniture can be time consuming because of the hardware needed, the tools that are used, the adjustments needed for the drawer to open and close properly, and the adjustments needed for the drawer position to look aesthetically pleasing. The manual installation of the drawer slide requires handling of screws and tools. Imprecise installation of screws can cause improper alignment of the drawer slides which will require adjustment.

Accordingly, there is a need for easily and quickly mounting drawer slides to drawer boxes, panels of cabinet framework, and other furniture without the use of tools in order to reduce/eliminate adjustments after installation.

### SUMMARY

An object of the present invention is to eliminate the need for the use of tools or screws when installing mounts/drawer slides to drawer boxes, cabinet framework, and the like, according to an embodiment of the present invention.

According to an embodiment of the present invention, there is a mounting system for a cabinet framework comprising an arm having at least one pre-installed insertion component on a side of the arm, the at least one pre-installed insertion component configured to attach to a first panel having at least one pre-machined receiving point. There is a base having a topside and an underside, the base configured to slidably receive the arm at the topside, and the base comprising an opening configured to interlock with a button and the underside of the base having at least one pre-installed fastening component. The at least one pre-installed fastening component having a bottom surface and a top surface, wherein the top surface is attached to the underside of the base; and the bottom surface fastens to a pre-machined mating point of one or more pre-machined mating point in a second panel, and the one or more pre-machined mating points correspond to the at least one pre-installed fastening component. There is a button located in a cavity of the second panel, the cavity located adjacent to the pre-machined mating point corresponding to the at least one pre-installed fastening component.

According to another embodiment of the present invention there is a mounting system for a cabinet framework comprising an arm having at least one pre-installed insertion component on a side of the arm. The at least one pre-installed insertion component configured to attach to at least one pre-machined receiving point. There is a base having a topside and a underside, the base configured to slidably receive the arm; the underside of the base attachable to at least one pre-installed fastening component, wherein the at least one pre-installed fastening component has a bottom surface and a top surface. The top surface is attached to the underside of the base and the bottom surface fastens to at least one pre-machined mating point in a panel of the cabinet framework. There is a quantity of the at least one pre-machined mating point corresponds to the at least one of pre-installed fastening component.

According to another embodiment of the present invention, there is a method of installation of a mount having pre-attached fasteners for mounting to panels having pre-machined receiving openings, the mount comprising a base and a slidable arm, the method of installation comprising press-fitting at least one pre-attached insertion component located on a side of the arm of the mount into a substrate having corresponding pre-machined receiving points, inserting a button into a pre-machined cavity located in a cabinet framework, locking at least one pre-attached fastening component located on a side of the base of the mount into corresponding pre-machined mating points on the cabinet framework, and sliding the arm connected to the substrate into the base locked to the cabinet framework such that the arm and base are aligned.

These features, advantages and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates a side, front, top perspective view of the fully assembled mount with pre-attached/pre-installed insertion components, according to an embodiment.

FIG. 2 illustrates a top, front, side perspective view of the fully assembled mount with pre-attached/pre-installed insertion components of FIG. 1, according to an embodiment.

FIG. 3 illustrates a front view of the fully assembled mount with a pre-attached/pre-installed insertion component and a pre-attached/pre-installed fastening component of FIG. 1, according to an embodiment.

FIG. 4 illustrates a side view of the fully assembled mount with pre-attached/pre-installed insertion components and pre-attached/pre-installed fastening components of FIG. 1, according to an embodiment.

FIG. 5 illustrates a bottom view of the fully assembled mount of FIG. 1 with pre-attached/pre-installed fastening components and opening, according to an embodiment.

FIG. 6A illustrates an exploded bottom, side perspective view of an arm of the mount aligned with a panel, the arm having pre-attached/pre-installed insertion components on the top of the arm aligned with pre-machined receiving points of the panel, according to an embodiment.

FIG. 6B illustrates the arm of the mount positioned on the panel of FIG. 6A, illustrating the pre-attached/pre-installed insertion components of the arm prior to insertion into the pre-machined receiving points of the panel, according to an embodiment.

FIG. 6C illustrates the arm of the mount inserted in the panel in which the fully pre-attached/pre-installed insertion components of the arm are fully inserted into the pre-machined receiving points of the panel, according to an embodiment.

FIG. 7 illustrates an exploded top, side perspective view of a fully assembled mount in an extended position prior to attaching to a panel with pre-machined mating points, according to an embodiment.

FIG. 8 illustrates another exploded top, side perspective view of the fully assembled mount of FIG. 7 with pre-attached/pre-installed insertion components located on the top of the arm and pre-attached/pre-installed fastening components located on a bottom of the mount aligned with the pre-machined mating points of the panel and the button substantially aligned with the cavity of the panel, according to an embodiment.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

Mounts can also be referred to as drawer slides. There are currently no solution for tool-less installation of any mounts 6, whether side mounts or under mounts to panels 24. The mount 6 becomes easier to install, faster to install, and eliminates the need for vertical and lateral adjustments. These pre-attached/pre-installed fasteners can be pre-attached/pre-installed insertion components 4 or pre-attached/pre-installed fastening components 16 located on different sides of the mount respectively, typically on opposing sides of the mount respectively. For example, pre-attached/pre-installed insertion components 4 are located on one side of the mount 6 (e.g. top side/inner facing side of the mount) and pre-attached/pre-installed fastening components 16 are located on another side of the mount 6 (e.g. bottom side/outer facing side of the mount). The pre-attached/pre-installed fasteners mate with pre-machined receiving openings. Pre-machined refers to receiving openings that have been pre-drilled, pre-routed, pre-bored. Receiving openings refer to a mating point 14 or receiving point 26. A mating point 14 is pre-routed into a substrate and generally mates with a pre-attached/pre-installed fastening component 16. A receiving point 26 is a hole pre-drilled/pre-bored into another substrate and generally mates with the pre-attached/pre-installed insertion component 4.

The pre-attached/pre-installed fasteners can be attached/installed to any surface such as wood or composite panel, and can be installed just as easily as a mount 6. For example, the pre-attached/pre-installed insertion components 4 and pre-attached/pre-installed fastening components 16 can be installed on closet rods, hooks, sconces, leg levelers, hinges, drawer pulls, or any other furniture, cabinet or closet hardware.

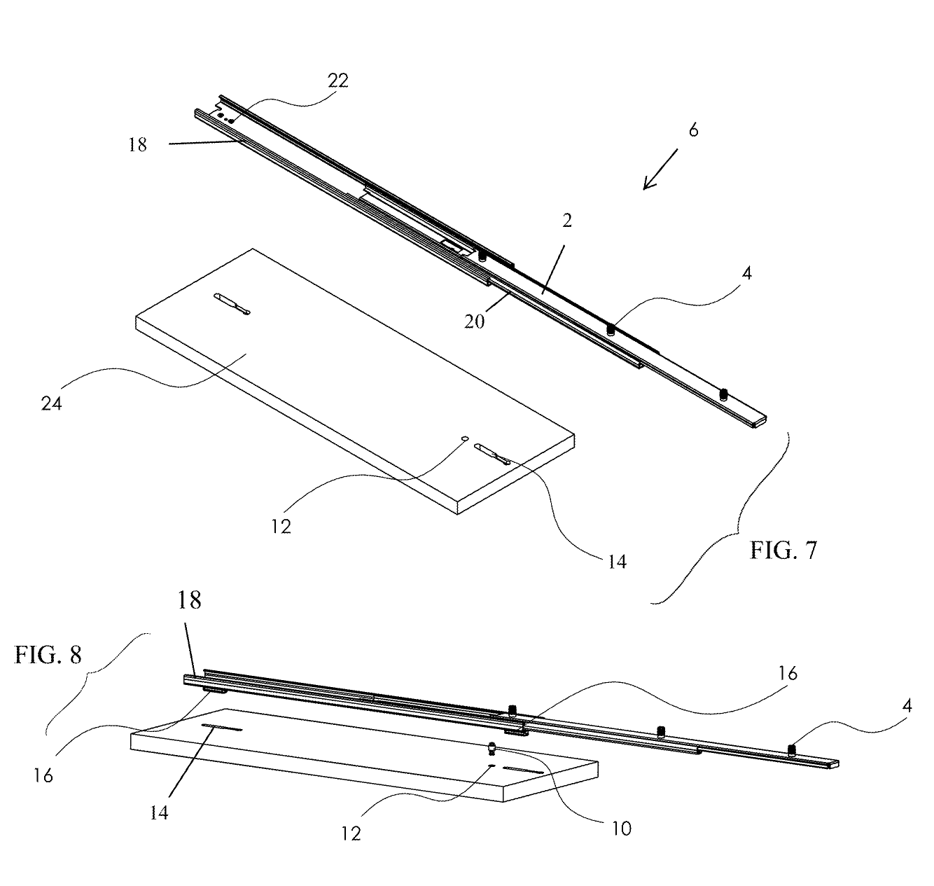

The preferred embodiments make the function, strength and durability of the mount 6 better than the existing technology. The means of installing the mount 6 is different than the existing technology because it does not require any tools, such as a screwdriver, nor does it require handling of loose hardware (screws) aside from a spring button 10 (not shown, see FIG. 8). As noted, there are pre-attached/pre-installed fasteners that mate with corresponding pre-machined receiving openings. The mount 6 is easier to install and easier to align on the panel 24 because the pre-attached/pre-installed insertion components 4 and the pre-attached/pre-installed fastening components 16 protrude from the side of the mount 6 and can drop right into the pre-machined receiving openings. The system of tool-less attachment makes installation of assembled cases, such as a cabinet, with limited internal space easier as limited space makes it more difficult to use tools such as drills to install mounts 6 inside of a cabinet.

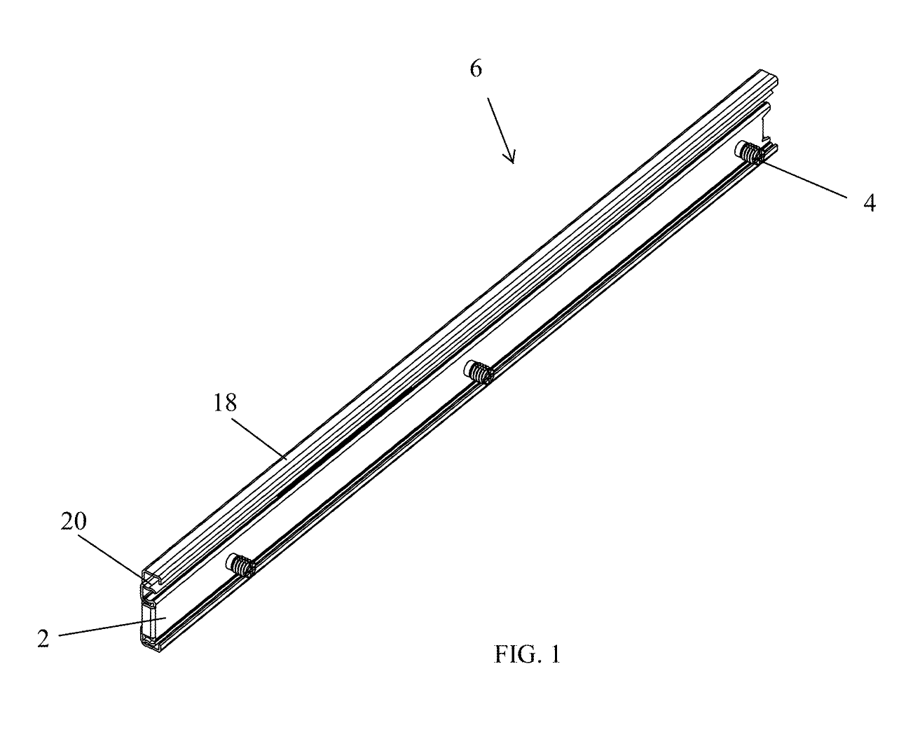

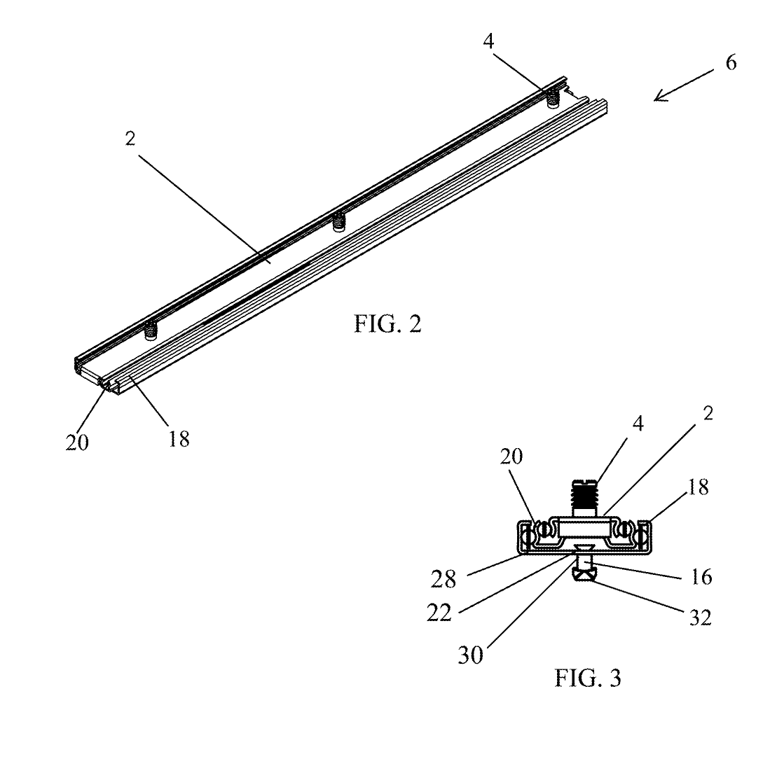

FIG. 1 and FIG. 2 illustrate perspective views of the fully assembled mount 6 with pre-attached/pre-installed insertion components 4, according to an embodiment. The mount 6 can be any type of mount (e.g. a drawer slide); however, the preferred embodiment shows either a sidemount or an undermount. A sidemount attaches the sides of a drawer box to the cabinet framework. An undermount attaches the bottom of a drawer box to the cabinet framework. The mount 6 comprises a base 18, rail 20, and arm 2. The mount 6 can be made from stamped steel; however, other metals can also be contemplated. There is at least one pre-attached/pre-installed insertion component 4 attached to a side (e.g. top side) of the arm 2. The pre-attached/pre-installed insertion components 4 are substantially spaced along the top side of the arm 2.

The base 18 is the portion of the mount 6 that attaches to the panel 24. On the underside 28 of the base 18, there are pre-attached/pre-installed fastening components 16. The opposing side of the underside 28 of the base 18 houses the rail 20 and the mount 6 is formed by sliding the arm 2 into the rail 20. The pre-attached/pre-installed fastening components 16 (not shown, see FIG. 3) allow the mount 6 to attach to the panel 24 of the cabinet framework by simply sliding on, snapping in or press fitting into the machined area of the panel 24 of the cabinet framework and the use of tools or screws to attach the mount 6 is unnecessary. Machined areas include the cavity 12, mating point 14 and receiving point 26 located on a panel 24. The pre-attached/pre-installed insertion components 4 and pre-attached/pre-installed fastening components 16 can be slide fasteners, snap fasteners, or other press fit fasteners. Examples of press fit fasteners are dowels. The dowels can be barbed or not. Examples of slide fasteners are channel locks. Examples of snap fasteners are h-clips (clip-locks).

The rail 20 sits between the base 18 and the arm 2. The rail 20 is configured to slide along the inside of the base 18 on one side of the rail 20 (e.g. bottom side of the rail) and the rail 20 is configured to allow the arm 2 to slide along the rail 20 on the opposing side of the rail 20 (e.g. top side of the rail). The arm 2 is configured to slide along the rail 20 on one side of the arm 2 (e.g. bottom side of the arm 2) and on the opposing side of the arm 2 (top side), pre-attached/pre-installed insertion components 4 are removably attached to the arm 2. The pre-attached/pre-installed insertion components 4 allow the mount 6 to attach to the drawer box by simply sliding on, snapping in or press fitting into the machined area of the panel 24 of the drawer box and the use of tools or screws to attach the mount 6 is unnecessary. Examples of press fit pre-attached/pre-installed insertion components are dowels. The dowels can be barbed or not. Examples of slide fasteners are channel locks. Examples of snap fasteners are fasteners disclosed in U.S. Pat. No. 9,810,253, U.S. Pat. No. 9,677,589, and U.S. Pat. No. 9,090,318, each of which are incorporated herein by reference in their entirety. As shown in FIG. 1 and FIG. 2, the pre-attached/pre-installed insertion components 4 are barbed dowels made from a plastic nylon material but other materials can be contemplated. In the present embodiment, the barbed dowels 4 are pre-attached to the arm 2 by screws.

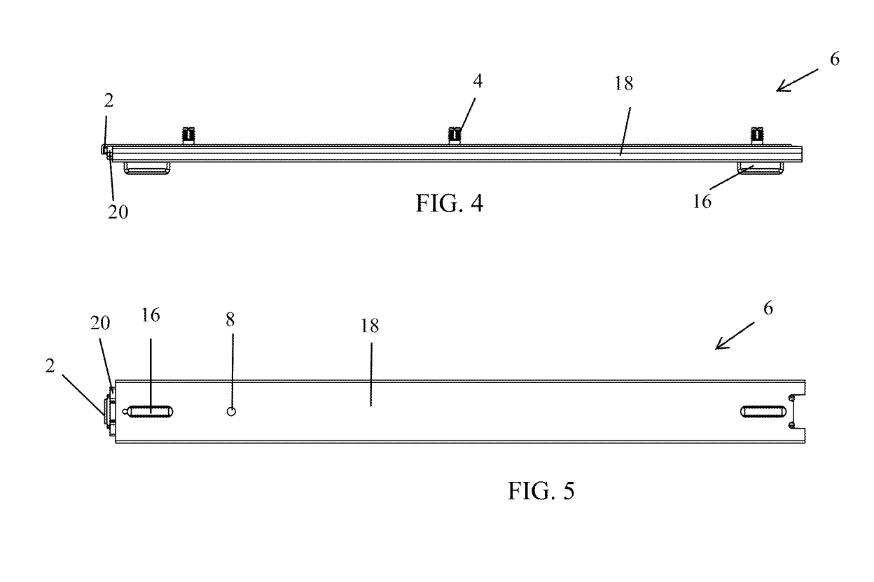

FIG. 3 and FIG. 4 illustrate a front view and a side view of the fully assembled mount 6 with pre-attached/pre-installed insertion components 4 and pre-attached/pre-installed fastening components 16. The surface of the pre-attached/pre-installed fastening components 16 attached to the underside 28 of the base 18 is the top surface 30 of the pre-attached/pre-installed fastening components 16. The top surface 30 of the pre-attached/pre-installed fastening component 16 is removably attached to the underside 28 of the base 18 with a screw 22. The top surface 30 of the pre-attached/pre-installed fastening component 16 is substantially flush against the underside 28 of the base 18 when fully attached by the screw 22. The bottom surface 32 of the pre-attached/pre-installed fastening components 16 fastens to a pre-machined mating point 14 (not shown, see FIG. 7) of a panel 24. In the embodiment disclosed, the bottom surface 32 of the pre-attached/pre-installed fastening components 16 is a channel lock that mates with the rout, i.e., pre-machined mating point 14. When the user inserts the bottom surface 32 of the pre-attached/pre-installed fastening components 16 into the wider groove of the pre-machined mating point 14, the user then slides the base 18 towards the narrow groove of the pre-machined mating point 14. When the pre-attached/pre-installed fastening components 16 is mating with the pre-machined mating point 14, the underside of the base 18 is substantially flush against the panel 24 of the cabinet framework.

When the pre-attached/pre-installed insertion components 4 mates with the pre-machined receiving point 26 of another panel 24 of a drawer box, the arm 2 is substantially flush against the panel 24 of the drawer box. The base 18 is the portion of the mount 6 that attaches to the panel 24 of cabinet framework. The arm 2 is the portion of the mount 6 that attaches to the panel 24 of the drawer box. There is a rail 20 between the base 18 and arm 2 that is used to extend the mount 6. The pre-attached/pre-installed insertion components 4 illustrated in FIG. 3 is a barbed dowel and the pre-attached/pre-installed fastening components 16 is a channel lock. However, the barbed dowel can be used as a pre-attached/pre-installed fastening component 16 and the channel lock can be used as a pre-attached/pre-installed insertion component 4, i.e., they are interchangeable so long as the panel 24 of the drawer box or cabinet framework are machined with the necessary pre-machined mating point 14 or pre-machined receiving point 26. In other words, the barbed dowels and the channel locks can be used for either attachment. For example the barbed dowels can be attached to the cabinet framework instead by press fitting into the panel 24 of the cabinet framework and the channel lock can be used to attach the arm 2 to the drawer box. Alternatively, the pre-attached fasteners can be the same on the arm 2 and base 18.

FIG. 5 illustrates a bottom view of the fully assembled mount 6 of FIG. 1 with pre-attached/pre-installed fastening components 16 and an opening 8, according to an embodiment. The opening 8 is located in the base 18 and is aligned with the pre-attached/pre-installed fastening components 16. In this embodiment, the pre-attached/pre-installed fastening components 16 is a channel lock. During assembly, when the channel lock is almost fully fastened with the pre-machined mating point 14, the opening 8 aligns with the cavity 12 located on the panel 24 cabinet framework and the button 10 (see FIG. 8) springs up and interlocks with the opening 8. This ensures the mount 6 is in the proper lateral position on the panel 24 of the cabinet framework. As mentioned previously, the pre-attached/pre-installed fastening component 16 can be slide fasteners, snap fasteners, or press fit fasteners. Before installing the mount 6, panels 24 of drawer boxes or cabinet framework are pre-machined with the necessary routing and drilling patterns required for the pre-attached/pre-installed insertion components 4 and pre-attached/pre-installed fastening components 16 to attach to the panels 24 of the drawer box or cabinet framework thus eliminating the need for any adjustment after installation. Pre-machined routing and drill holes located on drawer box panels are pre-machined receiving point 26. Pre-machined routing and drill holes located on cabinet framework panels are pre-machined mating points 14.

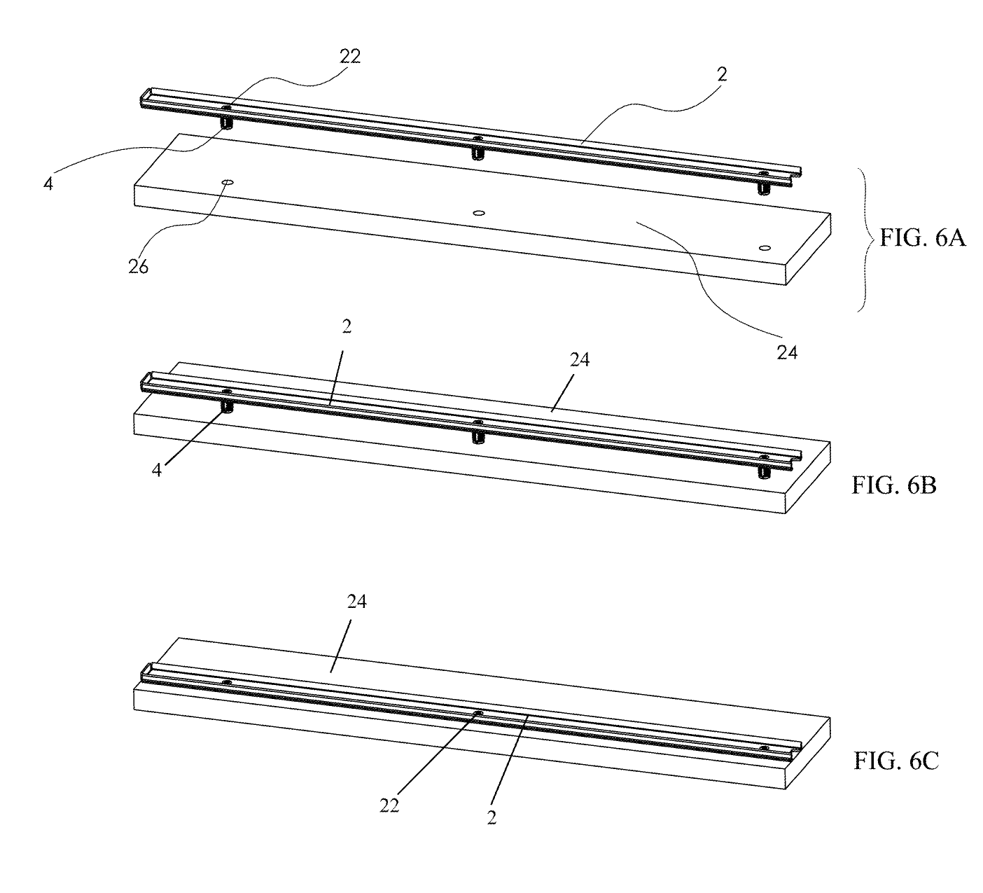

FIGS. 6A-6C illustrate installing the arm 2 of the mount 6 to a panel 24 of a drawer box, according to an embodiment. When the pre-attached/pre-installed insertion components 4 are engaged in the pre-machined receiving point 26, the side of the arm 2 (top side) comprising the pre-attached/pre-installed insertion components 4 is substantially flush against the panel 24 of a drawer box (see FIG. 6C). In FIGS. 6A-6C, the pre-attached/pre-installed insertion components 4 are barbed dowels. However, the pre-attached/pre-installed insertion components 4 can be slide fasteners, snap fasteners, or other press fit fasteners. The pre-attached/pre-installed insertion components 4 attach the arm 2 to the panel 24 of the drawer box by press fitting into holes predrilled into the side panel of the drawer box. In this embodiment, the pre-machined receiving point 26 are 8 millimeter diameter predrilled holes; however, depending on what the pre-attached/pre-installed insertion components 4 are, the pre-machined receiving point 26 can be a different diameter, pre-routed slot and the like.

FIG. 6A illustrates an exploded view of the arm 2 of the mount 6 aligned with the panel 24 with the pre-attached/pre-installed insertion components 4 of the arm 2 aligned with the pre-machined receiving point 26 of the panel 24, according to an embodiment. In this embodiment, the pre-attached/pre-installed insertion components 4 are barbed dowels, which are attached to the arm 2 by screws 22. Once the alignment is made, the barbed dowels are attached to the panel 24 of the drawer box by press fitting into the pre-machined receiving point 26. The quantity of the pre-attached/pre-installed insertion components 4 correspond to the quantity of the pre-machined receiving point 26. In this embodiment, the pre-machined receiving points 26 are holes predrilled into the drawer box side panel 24. Press-fitting the barbed dowels into the predrilled holes of the drawer box side panel 24 requires minimal force due to the design of the barb geometry and the material used to make the barbed dowel, thus it can be pressed in by hand. Three barbed dowels would be used, unevenly spaced, for strength and to avoid incorrect installation. The barbed dowels permanently secure to the panel 24, but the screws can be removed to detach the arm 2 if necessary. The barb dowels press fit into the predrilled holes until the arm 2 is substantially flush against the panel 24 of the drawer box.

FIG. 6B illustrates the pre-attached/pre-installed insertion components 4, in this embodiment, they are barb dowels, aligned with predrilled holes before pressing the barb dowels into the predrilled holes. FIG. 6C illustrates the barb dowels press fitted into the predrilled holes until the arm 2 is substantially flush against the panel 24. In the case of a cabinet, the panel 24 is a panel of the drawer box. The user press fits the barbed dowels attached to the arm 2 into the side of the panel 24 on both sides of the drawer box. Once the arm 2 is installed, the user slides the arm 2 into the rail 20 of the mount 6 which is attached to the base 18 of the mount 6. The base 18 comprising the rail 20 is attached to the panel 24 of the cabinet framework, specifically, the underside 28 of the base 18 is substantially flushed against the panel 24 when the pre-attached/pre-installed fastening components 16 fasten to a pre-machined mating point 14.

FIGS. 7-8 illustrate exploded perspective views of a mount 6 in an extended position (i.e. extended mount) prior to attaching to a panel 24 with pre-machined receiving openings. In the embodiment shown, the pre-machined receiving openings are pre-machined mating points 14 of a panel 24 of the cabinet framework. Specifically, the pre-machined mating points 14 are pre-routed slots. The quantity of the pre-machined mating points 14 corresponds to the quantity of the pre-attached/pre-installed fastening components. On the side of the arm 2 (top side) facing the panel 24 of the drawer box, there are pre-attached/pre-installed insertion components 4.

In this particular embodiment illustrated in FIG. 7, the pre-attached/pre-installed insertion components 4 are barbed dowels. The arm 2 extends by sliding on the rail 20 located between the base 18 and the arm 2. The base 18 is attached to the panel 24 of the cabinet framework by inserting the pre-attached/pre-installed fastening components 16 (not shown, see FIG. 8) into the pre-machined mating points 14. The pre-attached/pre-installed fastening components 16 can be channel locks. The channel lock can be from a die cast zinc alloy but can also made of a plastic material or stamped steel. The channel lock attaches the base 18 to the piece of furniture, cabinet framework, or closet. The channel lock slides into a pre-machined mating point 14, which in this embodiment is a pre-routed slot, i.e., a pre-routed keyhole slot. Once the channel lock fastens with the pre-routed slot, the base 18 of the mount 6 is substantially flush against the panel of the furniture, cabinet framework, or closet. The spring button 10 is made from a die cast material but can be made from plastic, cold formed steel or stamped steel. The button 10 springs up from the cavity 12 and interlocks with the opening 8 (not shown, see FIG. 5) to lock the base 18 of the mount 6 in its installed position. There are screws 22 to secure the channel lock to the base 18 of the mount 6. There are screws 22 that also secure the barbed dowel to the arm 2.

In this particular embodiment illustrated in FIG. 7, the pre-machined mating points 14 are pre-machined routed slots that can receive the pre-attached/pre-installed fastening components 16 (not shown, see FIG. 8). Adjacent to the pre-machined mating point 14, there is a cavity 12 in the panel 24 that holds a button 10. FIG. 8 illustrates the button 10, which is a spring button and when the button 10 fastens with the opening 8 (not shown, see FIG. 5), of the mount 6, this provides additional fastening strength and prevents lateral movement of the mount 6 once it is installed. The spring button 10 can be integrated into the base 18 so to avoid separate handling of the button. This integration can eliminate one step in the process of installation, making it a little easier and faster. The channel lock profile (not shown, see FIG. 3) can be stamped from the base 18 of the mount 6 to eliminate the need to attach these two separate entities together during manufacturing. The button 10 can be cylindrically shaped allowing it to fit into the cavity 12 located in the panel 24. The height at which the button 10 protrudes out from the cavity 12 depends on the depth of the cavity 12. When the button 10 is in a relaxed state, the top portion of the button 10 peaks above the upper most part of the cavity 12.

When the user inserts the channel lock of the mount 6 into the wider groove of the pre-machined mating point 14, the user then slides the mount 6 towards the narrow groove of the pre-machined mating point 14 to fully engage the channel lock. In doing so, the user also pushes on the spring button 10 while sliding the mount 6 with pre-attached fastening component 16. When the pre-attached/pre-installed fastening components 16, such as a channel lock, fastens with the pre-machined mating point 14, the opening 8 interlocks with the button 10. This ensures that the mount 6 is in the proper lateral position on the cabinet.

There is a method of installation of mounts having pre-attached fasteners for mounting to panels and the like, the panels having pre-machined receiving openings. The method of installation comprises press-fitting at least one pre-attached insertion component 4 located on a side of an arm 2 into a substrate having corresponding pre-machined receiving points 26, inserting a button 10 into a pre-machined cavity 12 located on a cabinet framework, locking at least one pre-attached fastening component 16 located on a side of a base 18 into a cabinet framework having corresponding pre-machined mating points 14, and sliding the arm 2 connected to the substrate into the base 18 connected to the cabinet framework such that the arm 2 and base 18 are aligned. To lock the pre-attached/pre-installed fastening components with the pre-machined mating point 14, the user slides the base 18 in the proper direction for full engagement until a clicking sound is heard. In sliding the base 18, the user presses/pushes on the button 10 to facilitate the locking.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A mounting system for a cabinet framework comprising:
an arm having at least one pre-installed insertion component on a side of the arm, the at least one pre-installed insertion component configured to attach to a first panel having at least one pre-machined receiving point,
a base having a topside and an underside, the base configured to slidably receive the arm at the topside, the base comprising an opening configured to interlock with a button,
the underside of the base having at least one pre-installed fastening component; the at least one pre-installed fastening component having a bottom surface and a top surface, wherein the top surface is attached to the underside of the base; and the bottom surface fastens to a pre-machined mating point of one or more pre-machined mating point in a second panel, and the one or more pre-machined mating points correspond to the at least one pre-installed fastening component; and
the button located in a cavity of the second panel, the cavity located adjacent to the pre-machined mating point corresponding to the at least one pre-installed fastening component.

2. The mounting system of claim 1, wherein the first panel comprises a surface of a drawer box and the second panel comprises a surface of the cabinet framework.

3. The mounting system of claim 1, wherein the at least one pre-installed insertion component is a dowel.

4. The mounting system of claim 3, wherein the dowel is barbed and made from a plastic nylon.

5. The mounting system of claim 1, wherein the at least one pre-installed insertion component is a slide fastener.

6. The mounting system of claim 1, wherein the at least one pre-installed insertion component is a snap fastener.

7. The mounting system of claim 1, wherein the at least one pre-installed insertion component is a press fit fastener.

8. The mounting system of claim 1, wherein the at least one pre-installed fastening component is a dowel.

9. The mounting system of claim 1, wherein the at least one pre-installed fastening component is a slide fastener.

10. The mounting system of claim 1, wherein the at least one pre-installed fastening component is a snap fastener.

11. A mounting system for a cabinet framework comprising:
an arm having at least one pre-installed insertion component on a side of the arm, the at least one pre-installed insertion component configured to attach to at least one pre-machined receiving point;
a base having a topside and a underside, the base configured to slidably receive the arm; the underside of the base attachable to at least one pre-installed fastening component; wherein the at least one pre-installed fastening component has a bottom surface and a top surface;
the top surface is attached to the underside of the base and the bottom surface fastens to at least one pre-machined mating point in a panel of the cabinet framework; and
a quantity of the at least one pre-machined mating point corresponds to the at least one of pre-installed fastening component.

12. The mounting system of claim 11, wherein the at least one pre-installed insertion component is a dowel.

13. The mounting system of claim 12, wherein the dowel is a barbed dowel.

14. The mounting system of claim 13, wherein the barbed dowel is made from a plastic nylon.

15. The mounting system of claim 11, wherein the at least one pre-installed fastening component is a barbed dowel.

16. The mounting system of claim 11, wherein the at least one pre-installed fastening component is a slide fastener.

17. The mounting system of claim 11, wherein the at least one pre-installed fastening component is a snap fastener.

18. A method of installation of a mount having pre-attached fasteners for mounting to panels having pre-machined receiving openings, the mount comprising a base and a slidable arm, the method of installation comprising:
a) press-fitting at least one pre-attached insertion component located on a side of the arm of the mount into a substrate having corresponding pre-machined receiving points,
b) inserting a button into a pre-machined cavity located in a cabinet framework,
c) locking at least one pre-attached fastening component located on a side of the base of the mount into corresponding pre-machined mating points on the cabinet framework, and
d) sliding the arm connected to the substrate into the base locked to the cabinet framework such that the arm and base are aligned.

19. The method of claim 18, wherein the step of locking comprises sliding the at least one pre-attached fastening component.

20. The method of claim 18, further comprising pushing on the button and sliding the at least one pre-attached fastening component.
